(19) United States
(12) Patent Application Publication
(10) Pub. No.: US 2005/0192893 A1
(43) Pub. Date: Sep. 1, 2005

(54) Authenticated messaging-based transactions

(76) Inventors: John Ernest Keeling, Reston, VA (US); Steve Gaitten, Hamilton, VA (US); Michael Vincent Morello, Gainesville, VA (US); Warren Denis McAllister, Dublin (IE); Billy Gene White, Great Falls, VA (US)

Correspondence Address: FISH & RICHARDSON P.C., P.O. BOX 1022, MINNEAPOLIS, MN, 55440-1022, US

(21) Appl. No.: 10/995,548

(22) Filed: Nov. 24, 2004

Related U.S. Application Data
(60) Provisional application No. 60/524,029, filed on Nov. 24, 2003.

(51) Int. Cl. G06F 17/60

(52) U.S. Cl. 705/39

(57) ABSTRACT

Messaging-based transactions may be transmitted by using an intermediary host to receive transaction information from a sender. The sender and the transaction information are authenticated, and the transaction information is packaged as a transaction when the sender and the transaction information are authenticated. A trusted transaction message is generated configured to indicate to a recipient that the trusted transaction message has been authenticated, wherein the trusted transaction message is configured to execute the transaction when a recipient interacts with the transaction in the trusted transaction message. The trusted transaction message is transmitted.

### CROSS-REFERENCE TO RELATED APPLICATIONS

This application claims priority to U.S. Provisional Application No. 60/524,029, entitled “Systems and Methods for Authenticated Communications”, and filed on Nov. 24, 2004.

### TECHNICAL FIELD

This document relates to messaging systems used to authenticate electronic communications.

### BACKGROUND

The growth of communications networks, such as the Internet, enables a variety of transactions using a variety of electronic messaging tools. For example, banks sometimes provide online banking using online tools. While banks and bank customers are eager to harness the convenience and flexibility of one or more messaging tools, concerns about security may discourage the bank and bank customers from utilizing the messaging tools. Even if a bank is able to address bank security concerns, bank customer concerns may preclude the messaging tools from being widely adopted. As one example, a bank customer may reject bill-paying systems with electronic messaging feature sets if spam may be used to spoof or resemble ordinary electronic mail messaging.

### SUMMARY

In one general sense, messaging-based transactions may be enabled by accessing, from a trusted source, transaction parameters revealing at least a registrant identity, a transaction amount, and an identity for a creditor of the registrant. Payment parameters associated with the registrant may be accessed, including information related to a financial account designated by the registrant as available for application against payment requests. A message may be generated reflecting at least the creditor and the transaction amount, and configured to include a selectable object configured to trigger, upon selection by the registrant, a financial transfer of funds from the financial account to the trusted source in satisfaction of the transaction amount. The message is configured to reflect a trusted status afforded to the trusted source, and to the registrant such that the trusted status and selectable object are perceivable to the registrant, and such that the selectable object is accessible for selection by the registrant.

Implementations may include one or more of the following features. For example, accessing the transaction parameters may include accessing account information, a date of a bill, or a payment due. Accessing the transaction parameters may include accessing an amount of a bill from the creditor, accessing a monthly payment amount due, or accessing a full balance. Accessing the transaction parameters may include accessing a screen name, a legal name, an identification number, or a social security number. Accessing the transaction parameters may include authenticating the trusted source, or authenticating the transaction parameters.

The creditor may include the trusted source. The creditor may include an entity other than the trusted source. Accessing registered payment parameters may include accessing the registered payment parameters prior to delivery of the message. Accessing registered payment parameters may include accessing information related to a source of funds.

Accessing information related to the source of funds may include accessing account information, accessing credit card information, or accessing an electronic wallet.

Generating the message may include generating the message accessible through a messaging application. Generating the message may include generating the message outside of an Internet web browser. Accessing transaction parameters may include generating accessing transaction parameters outside of the context in which a debt was incurred.

Configuring the message may include providing an option to enable the registrant to select from among more than one financial account to transfer funds to the creditor, or providing an option that enables the registrant to specify a payment amount. Configuring the message may include providing an option that enables the registrant to specify payment in full, or providing an option that enables the registrant to specify payment of a minimum balance.

In another general sense, messaging-based transactions may be enabled by using an intermediary host to receive financial transaction information from a sender, packaging the financial transaction information as a transaction when the financial transaction information can be authenticated, generating a trusted transaction message configured to indicate to a recipient that the trusted transaction message has been authenticated, and transmitting the trusted transaction message. The trusted transaction message is configured to execute the transaction in response to recipient interaction with the transaction in the trusted transaction message

Implementations may include one of more of the following features. For example, using the intermediary host to receive the financial transaction information from the sender may include receiving a transaction feed related to multiple accounts and multiple events from a transaction host or receiving an electronic mail message. Using the intermediary host to receive the financial transaction information from the sender may include receiving a request to transmit a trusted transaction message with the financial transaction information to the recipient. Authenticating the financial transaction information may include comparing sender information with authoritative information for the sender. Authenticating the financial transaction information may include determining whether a trusted communications channel provided the financial transaction information, determining whether one or more similar transactions have previously occurred between the sender and the recipient, or determining whether a transaction type in the financial transaction information is found in a maintained list of acceptable transaction types.

Determining whether the transaction type is found in the maintained list of acceptable transaction types may include determining whether a scope of the transaction is within the threshold limits established with respect to the maintained list of acceptable transaction types, determining whether an amount of the transaction is within the threshold limits established with respect to the maintained list of acceptable transaction types, determining whether a type of goods or services in the financial transaction information is within the threshold limits established with respect to the maintained list of acceptable transaction types, or determining whether a vendor of goods or services in the financial transaction information is within the threshold limits established with respect to the maintained list of acceptable transaction types.

Packaging the financial transaction information as the transaction may include retrieving user financial information associated with a user enrolled in a bill payment service, associating the user financial information with the financial transaction information, and storing a pending transaction so that the recipient may interact with the trusted transaction message to execute the pending transaction.

In yet another sense, a computer program product that when executed generates a graphical user interface enabling a user to execute a transaction. The graphical user interface includes an inbox region illustrating a trusted transaction message alongside other messages that are not trusted transaction messages and a trusted mail message code segment indicating that the trusted transaction mail message has been authenticated and enabling a recipient to execute a transaction by interacting with the transaction in the trusted transaction mail message.

Implementations may include one or more of the following features. For example, the graphical user interface may include a reminder icon enabling a user to be reminded of the transaction appearing in the trusted transaction message, a calendar icon enabling a user to enter an event for the transaction in a calendaring system, or a help icon enabling a user to report fraud. The graphical user interface may include a help icon to establish a Voice Over Internet Protocol session with a call center, or to request a call back to a telephone from a customer service representative. The help icon may be configured to generate a help message requesting customer service. The help icon may be configured to provide customer and transaction information in the help message. The help icon may be configured to provide the help message to the customer call center.

### DESCRIPTION OF DRAWINGS

FIG. 1A illustrates an exemplary user inbox with a trusted icon associated with a trusted transaction message reserved for authenticated banking electronic mail messages indicating that the trusted transaction message has been authenticated and exchanged as part of a bill payment system.

FIG. 1B is an exemplary graphical user interface (GUI) illustrating a trusted mail message configured to execute a financial transaction.

FIG. 1C is an exemplary graphical user interface of a trusted transaction message that provides a bill payment history.

FIG. 1D is an exemplary graphical user interface of a confirmation message provided in response to the user selecting a ‘go pay bill’ button in order to execute a financial transaction.

FIG. 2 is an exemplary graphical user interface of a trusted instant message.

FIG. 3 illustrates an exemplary block diagram of a communications system configured to enable messaging-based transactions.

FIG. 4 is a flow chart of an exemplary process by which a client receives a trusted transaction message from a transaction host using an intermediary host.

FIG. 5 is a flow chart of an exemplary process by which a client receives a trusted transaction message in the form of a trusted mail message.

FIG. 6 is a flow chart of an exemplary process by which a client receives a trusted transaction message in the form of an instant message.

FIG. 7 is a flow chart of an exemplary process by which an intermediary host receives an unauthenticated mail message, authenticates the unauthenticated electronic mail message and transmits the electronic mail message as a trusted transaction mail message.

FIG. 8 is a flow chart of an exemplary process by which an intermediary host authenticates a transaction for use in a trusted transaction message.

FIG. 9 is a flow chart of an exemplary process by which an intermediary host may generate a trusted transaction message by interfacing with a partner.

FIG. 10 illustrates an exemplary user interface configured to provide bill paying services.

FIG. 11 illustrates an exemplary user interface configured to organize trusted transaction messages.

FIG. 12A is a flow chart of an exemplary process by which a user may be enrolled in a bill payment system.

FIG. 12B illustrates an exemplary user interface of a trusted message enabling an automatic bill payment customer to enroll another bill into the bill payment system.

FIG. 12C illustrates an exemplary user interface of a trusted message used by messaging service provider to enroll a user as a bill payment customer and also to enroll a bill into the bill payment system.

### DETAILED DESCRIPTION

An intermediary host receives financial transaction information related to a user's activities. The financial transaction information and a user's financial information are associated to generate a transaction. The transaction is then represented in a trusted transaction message so that the user may interact with trusted transaction message to execute the transaction.

To illustrate, an online service provider, such as America Online, may receive a transaction feed from a biller, a financial institution, or a transaction feed service. The transaction feed includes financial transaction information (e.g., a name, a purchase date, an account, an amount due, and a payment date) related to a user's activities resulting in a bill. The online service provider may parse the transaction feed, and associate the parsed portions with a user's financial information to generate a transaction. The intermediary host then stores the transaction and presents the user with an electronic mail message (a trusted transaction mail message) that the user may interact with to execute the transaction. For example, the user may select a “Pay Bill” button configured to execute the stored transaction and transfer finances from a particular checking account to the biller.

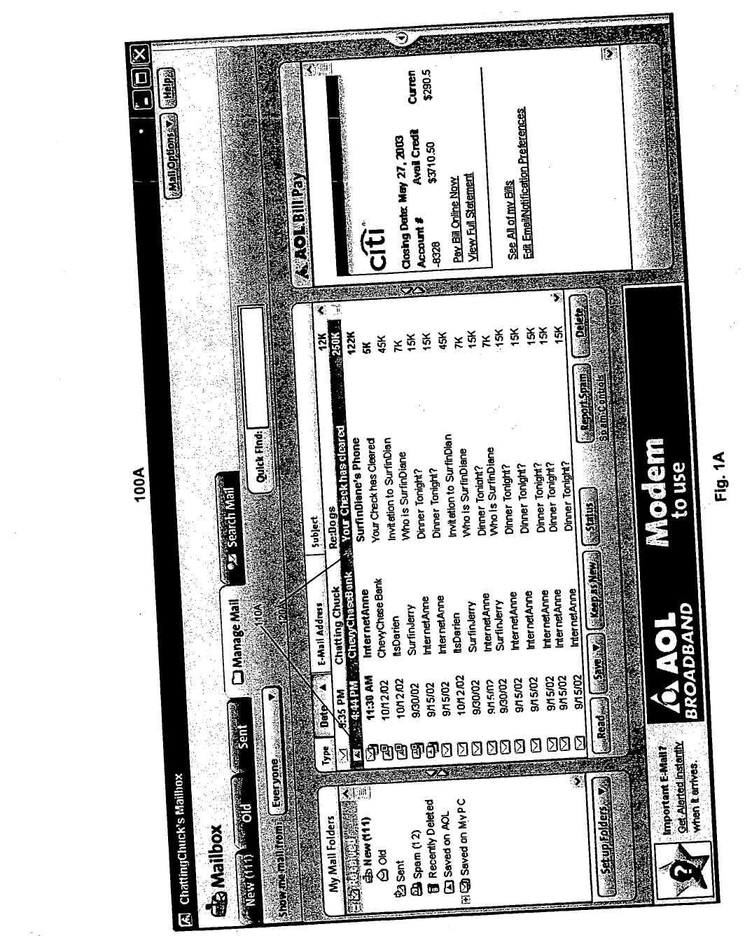

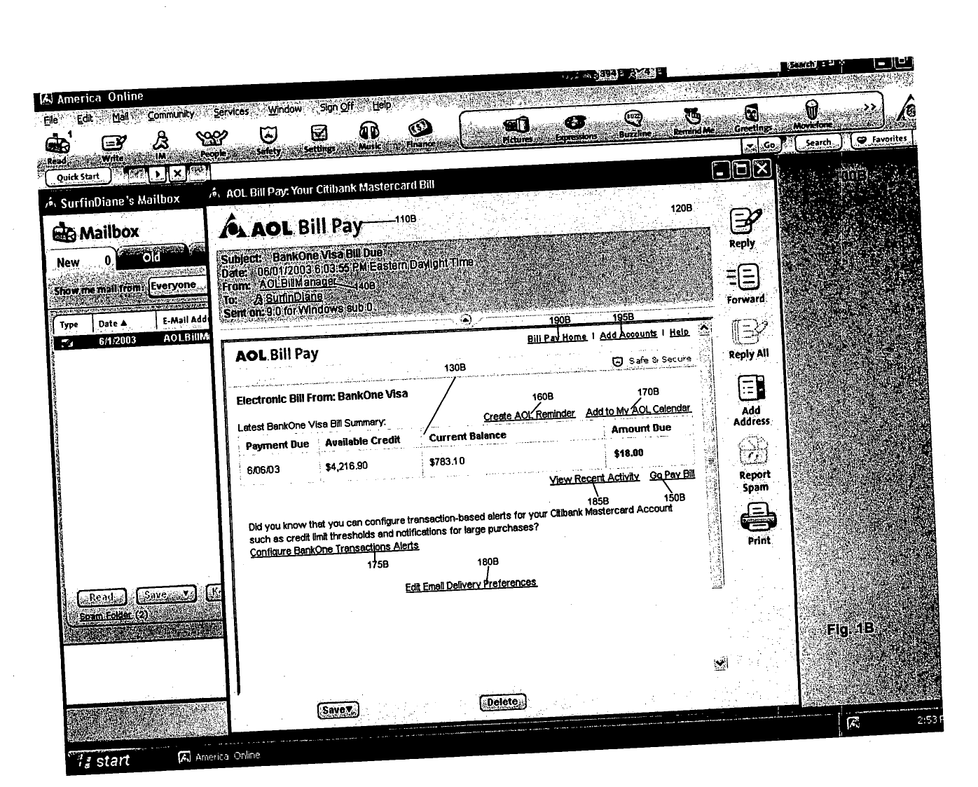

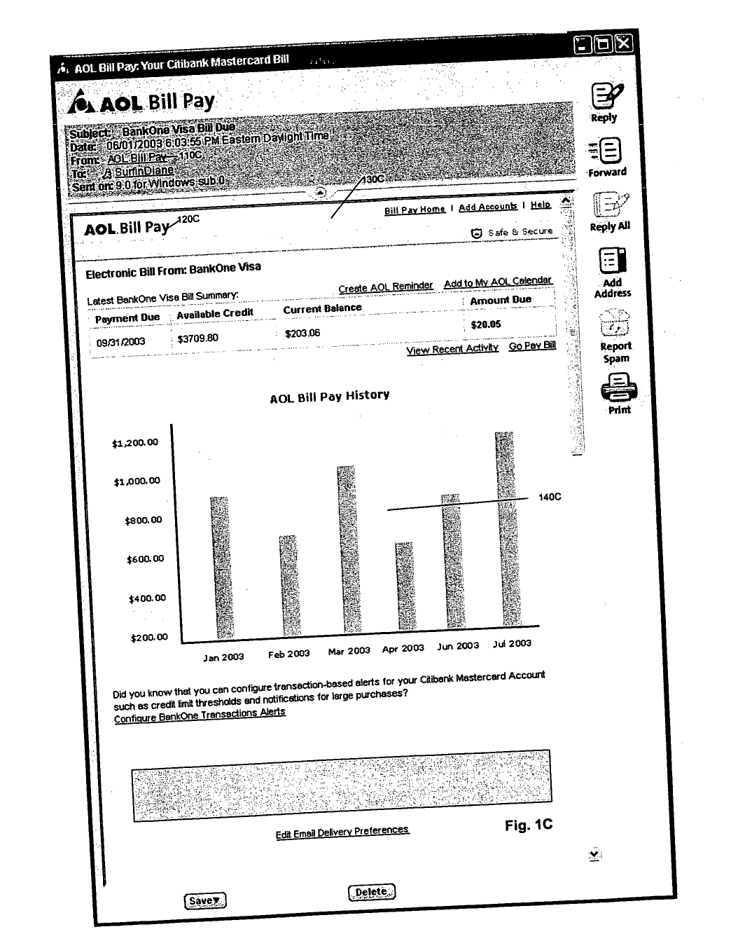

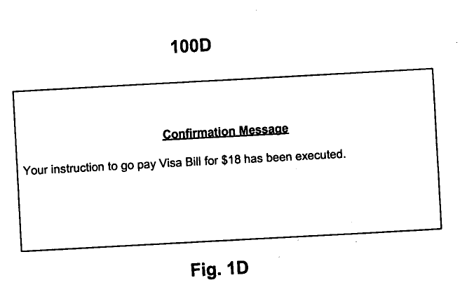

To illustrate, FIG. 1A provides an example of a trusted transaction message packaged such that a user can readily observe that a transaction message has been authenticated. An exemplary user inbox 100A is shown to include a financial icon 110A that is visually associated with a trusted transaction message 120A. The financial icon 110A is reserved for authenticated banking electronic mail messages, thus visually distinguishing the trusted transaction mail message 120A exchanged and authenticated as part of a bill payment system from other, perhaps non-authenticated messages. Moreover, because the special graphical appearance for the trusted transaction mail message 120A (e.g., financial icon 110A) cannot be used for unauthenticated messages, a user (e.g., a banking customer) may rely on a distinct ‘trusted’ appearance designating that the trusted transaction mail message 120A has been authenticated.

A degree of distinctiveness may be preserved between reserved fields and nonreserved fields. In one example, when the reserved status includes a silver chrome, other senders may be precluded from using (1) shades of silver, (2) any metallic color, or (3) other colors altogether. In another example, other senders may be allowed to use some distinguishing characteristics (e.g., a user may include a blue background) and prohibited from using characteristics that determined to be too similar to reserved characteristics (e.g., not be allowed to use a light gray background when a darker grey is reserved for trusted transaction messages).

Different degrees of distinctiveness may be specified based on similarity to a reserved characteristic and an importance associated with the reserved characteristic. For example, a sender may be allowed to use a striped blue-and-white pattern in the background portion when a checkered blue-and-white pattern is a reserved characteristic for an advertisement sent from an authenticated sender in a trusted transaction message. However, a sender may not be allowed to use any type of red pattern in the background portion of a message when the color red is reserved for trusted transaction messages sent to provide notification of suspected fraudulent activity.

Although FIG. 1A shows one form of financial icon 110A, multiple trusted icons may be used to represent different types of transactions. In one implementation, a first trusted icon may be used to represent trusted transaction mail messages for bill paying transactions while a second trusted icon may be used to represent trusted transaction mail messages for account statements. Similarly, the appearance of the trusted icon or trusted transaction message may appear differently to represent different degrees of trust or authentication. For instance, a first trusted icon may be used to represent a trusted transaction message from a third party identified as having an ongoing relationship with the recipient, while a different trusted icon is used to represent a trusted transaction message from an authenticated sender not having a relationship with the recipient. Yet another implementation may feature a third trusted icon used to enroll a recipient in a bill paying system, while a fourth trusted icon is used to represent a trusted transaction mail message with an authenticated sender, but with a transaction that has not been authenticated.

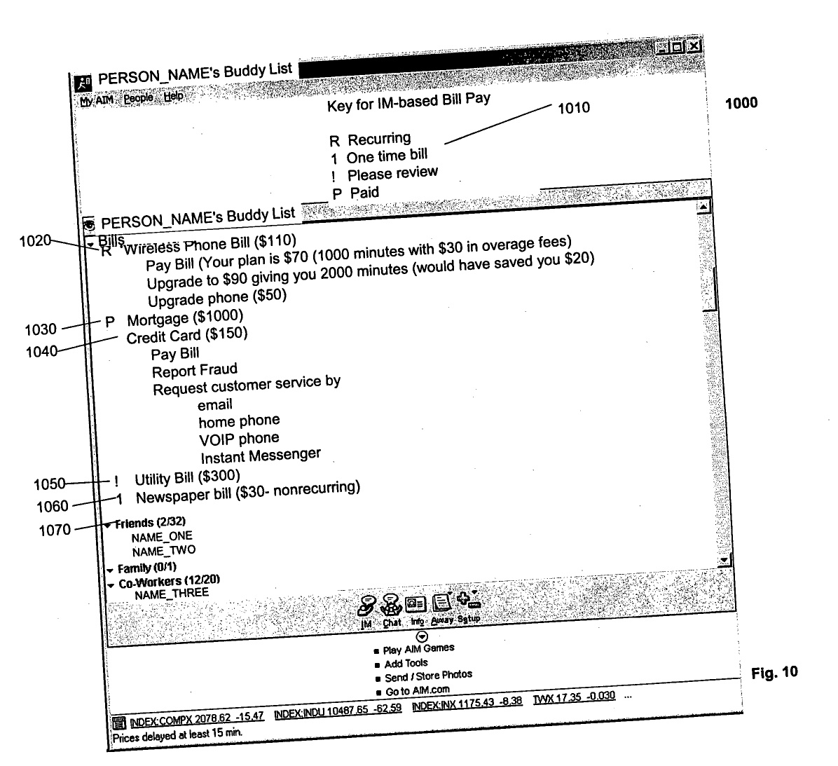

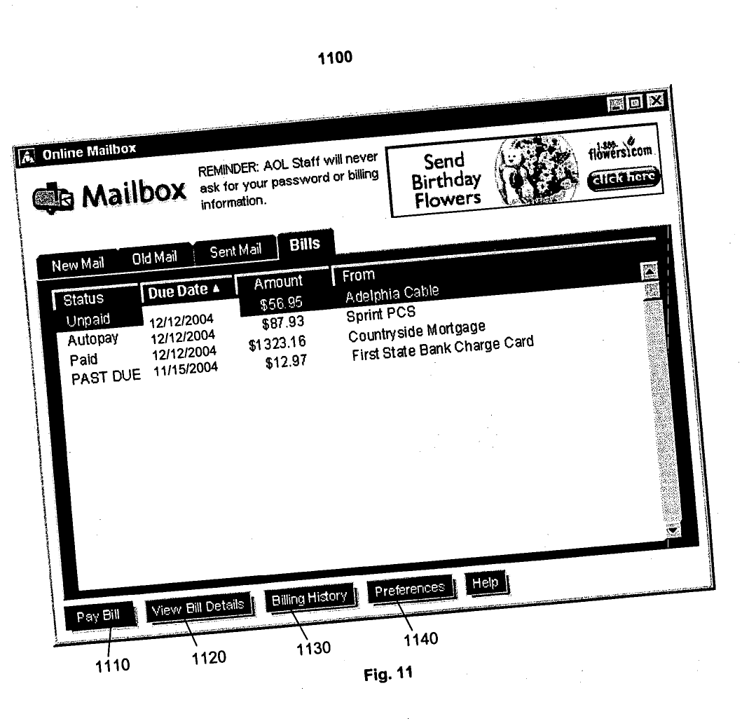

The reserved or special graphical appearance may convey the reserved status in a variety of manners. In one example, the reserved status is conveyed through use of a special tab (e.g., the ‘Bills’ buddy group in FIG. 10 or the ‘Bills’ tab shown in FIG. 11) that only presents messages that are authenticated to merit use of the reserved appearance. Other examples of information that may convey the reserved status may include a header, a color, a pattern, an icon, a font, a status flag, or an image.

FIG. 1B is an exemplary GUI 100B illustrating an electronic mail message used to execute a financial transaction. GUI 100B includes a reserved header 110B (“AOL Bill Pay” with the AOL logo), a reserved background 120B (featuring a blue background), a sender identifier 140B, an execution button 150B, a “Create Reminder” button 160B, an “Add to MyAOL Calendar” calendar button 170B, a “Configure BankOne Transaction Alerts” button 175B, an “Edit Email Delivery Preferences” button 180B, a “View Recent Activity” button 185B, a “Bill Pay Home button” 190B, and an “Add Accounts” button 195B.

Typically, the reserved header 110B and the reserved background 120B are used to graphically convey the authenticated or trusted status of a trusted transaction message exclusively reserved for use in electronic mail messages for which an intermediary host establishes the trusted nature of the transaction. Thus, untrusted systems (e.g., a system other than an intermediary host or to another system that has been authenticated) may be precluded from using aspects of the special visual appearance featured in the reserved header. Precluding untrusted systems from using aspects of the special visual appearance may include precluding the untrusted systems from using the reserved appearance parameters appearing in a mail header used by the trusted transaction message. Similarly, regardless or without consideration of trust level, systems other than the intermediary host may be precluded from using the color or pattern appearing in the reserved background 120B.

In one implementation, the reserved portion designating the reserved appearance (e.g., reserved header 110B and reserved background 120B) or triggers therefor are sent separate from a message delivered to a user. For instance, the reserved header 110B and reserved background 120B may be included in a transmission or packaging accompanying a message such that information specifying the accompanying fields is not available to a sending party. For example, in GUI 100B, the top bar in a window (e.g., blue field) reading “AOL Bill Pay: Your Citibank Mastercard Bill” may be specified external to a message that a sender is allowed to send. In one implementation, the reserved portion is sent by a label that designates one or more reserved graphical designators (e.g., trusted (e.g., reserved) icons, reserved headers, and reserved backgrounds) for the client to insert in a messaging label forming the trusted transaction message. The messaging label may be external to or packaged around an electronic mail message (or an instant mail message) that the client receives. In another example, the reserved portion is transmitted in a separate transmission from the client (e.g., using another communications port or protocol).

Alternatively, the reserved portion or triggers therefor may be sent within the message itself. In one example, the reserved portion is sent in electronic mail message header. The reserved portion may configure the appearance of the trusted mail message as the trusted mail message is rendered to a user in an inbox and as the trusted mail message is selected for viewing. In another example, the reserved portion may be sent as a reserved image embedded in an electronic mail message. An intermediary host may filter electronic mail messages to preclude other electronic mail messages from using the reserved portion without authorization from the intermediary host. Similarly, an intermediary host may analyze messages as they are being transmitted so that a recipient of a trusted transaction mail message may not forward the trusted transaction mail message, or forward the trusted transaction mail message in an unauthorized manner. For instance, an intermediary host may block trusted transaction mail message from being transmitted to anyone other than the biller, a customer service representative, or a dispute resolution authority. Thus, when a user attempts to act in a fraudulent manner by attempting to spoof one or more reserved portions in an electronic mail message header, e.g., by forwarding the message inappropriately, the intermediary host may analyze the electronic mail message header, detect the unauthorized use of the reserved portion, and take action responsive to suspected fraudulent activity (e.g., by notifying an official of the attempted fraudulent activity). The transaction description 130B describes a transaction, and thus enables a user to better understand the nature and scope of the transaction. While the format and content of the transaction description may vary with the underlying transaction, the transaction description 130B allows the user to see that a payment of $18.00 is due on Jun. 6, 2003 for a BankOne Visa transaction. The transaction description 130B also shows that the user has available credit of $4,216.90 and a current balance of $783.10.

The sender identifier 140B identifies the source of the trusted transaction message. In GUI 100B, the sender is “AOLBillManager.” Although, in this example, the sender identifier is associated with the identity of an account on an intermediary host (when AOL is the service provider), other sender identities may be used. For example, other sender identities associated with a particular bank or vendor may be used. Thus, in a slight variation on the transaction shown, another implementation may use a sender identity of “BankOne Visa Bill Manager” to identify a message from BankOne related to online bill paying.

The sender identity 140B may be reserved to preclude others from using the sender identity associated with the source of a trusted transaction message. For example, one or more mail processing gateways may be configured to reject received messages that use a sender identity associated with the transaction service (e.g., reject received mail messages from AOLBillManager) when the transaction service originates internally (e.g., on intermediary hosts), and thus would not be received through an external mail gateway. In another example, when the sender identity originates external to an intermediary host that performs authentication operations, the intermediary host may authenticate the sender identity. The sender identity may validate the transaction using a registered authority for the sender. When the sender identity or transaction is confirmed using the registered authority, the message may be processed or packaged as a trusted transaction message.

The execution button 150B includes a button, control, code segment, icon, or link enabling a user to execute the transaction by selecting or interacting with the execution button 150B. In the example shown, the execution button 150B is entitled “Go Pay Bill” and enables payment of the bill described in the transaction summary 130B. Selecting the execution button 150B may generate an execution command to a transaction server that transfers funds in an automated manner. In another example, selecting the execution button 150B may launch a browser window that further describes the transaction. A user may then confirm the transaction by interacting with the browser window.

Typically, the execution button 150B is configured to execute a transaction generated by a transaction intermediary such as a messaging service provider operating an intermediary host. For example, a user may enroll in a bill payment service offered by the messaging service provider. By enrolling in the bill payment service, a user provides the messaging service provider with financial and account information so that the messaging service provider may structure and present future transactions to a user for execution. The messaging service provider may receive transaction information from a biller, relate the transaction information to a particular user, structure a transaction linking the transaction information with the user's financial information, and present the transaction to the user in a trusted transaction message. Thus, the execution button 150B presents an intuitive and quick option to execute a transaction assembled by the messaging service provider. The seamless nature of the execution button 150 also may lead to wider adoption of electronic bill paying services because a user may only be asked to interface with the messaging service provider and a regularly-used messaging interface, rather than asking a user to interface with a separate and distinct user interface operated independently. Similarly, although a user may interface with a “Bill Pay Home” operated by a messaging service provider or with a financial web site operated by a separate and distinct financial institution, the volume of and nature of the “Bill Pay Home” or financial web site interaction may be reduced when the user may perform more of the interaction through the messaging interface.

“Create Reminder” button 160B may be used to generate a reminder at a time in the future. For example, a reminder may be generated that instructs a user to pay a bill within a specified period. The reminder may be sent using one or more messaging tools including pop-up notifications, instant messages, electronic mail messages, or by a proprietary application.

The “Add to MyAOL calendar” button 170B includes a button that adds information relating to the transaction to a calendar. The calendar informs the use of the event as it occurs. The user may access the calendar and press an execution button to execute the transaction.

The “Configure BankOne Transaction Alerts” button 175B may be used to configure the manner in which a client receives transaction alerts. For example, the user may request to receive alerts by electronic mail or instant messaging. In another example, the user may request to receive no more than a specified number of alerts per period of time (e.g., no more than one alert per day). Still another example may allow the user to request that the alert consolidate multiple transactions, or only feature transactions of a specified type (e.g., only on certain goods) or importance (e.g., over $500 or within specified financial thresholds, balances, or limits are reached).

The “Edit Email Delivery Preferences” button 180B may be used to configure how trusted transaction messages are delivered. For example, the user may request to receive trusted transaction messages to pay bills, but specify that trusted transaction messages related to account activity should not be sent. In another example, the user may indicate whether they would like the intermediary host to proactively correlate customer accounts with other billing authorities so that an automated bill paying message may be generated when the user is supported by the intermediary host and has been identified as a customer of the other billing authority. This may include a service provider comparing customer lists with a wireless carrier providing wireless phone service. When a customer is identified as being a service provider customer and a wireless carrier customer, the service provider may prompt the customer with a trusted transaction message, soliciting to establish services with respect to the wireless carrier, such as online bill payment through trusted transaction messages.

The “View Recent Activity” button 185B includes a control enabling a user to view recent activity for an account shown in the transaction description 130B. When the user interacts with the “View Recent Activity” button 185B, a browser window documenting recent transactions or a specified billing period launched. For example, a specified number of recent transactions or all transactions within the last billing month may be displayed.

The “Bill Pay Home” button 190B includes a control that launches a bill payment center on a client. For example, the “Bill Pay Home” button 190B may be configured to launch an application (e.g., a browser accessing a Bill Pay Web site) where a user may control their automated bill paying system.

The “Bill Pay Home” Button 190B may be used to configure one or more options for participation in a messaging-based transaction service. In one implementation, a user may be allowed to specify what reserved colors, reserved icons, reserved wallpapers and/or trusted messaging formats are used to represent a trusted transaction message. Thus, a user may elect to receive trusted transaction messages to pay bills via electronic mail but elect to receive instant messages notification related to the account activity. In another implementation, a user may be allowed to specify which type of trusted transaction messages the user elects to receive.

The trusted transaction mail message also may enable a user to specify an account that should be or was used to pay and/or indicate an amount of a payment. For example, some users may prefer to use some resources (e.g., a credit card providing additional product warranties) to pay certain bills (e.g., a good prone to failure and better able to take advantage of the additional product warranty). In another example, a user may seek to take advantage of a work-related expense account, a lower interest rate on a credit card, or the ability to shield some transaction for unwanted scrutiny (e.g., to better keep an anniversary gift a surprise).

The “Add Accounts” button 195B includes a control enabling a user to associate different accounts with a transaction service. In one example, adding an account enables the transaction service to be performed across multiple user identities. This may include adding another screen name, account name, or online identity to a list of identities enabled to execute transactions for a particular matter/user/financial account. In another example, the “Add Accounts” button is configured to allow a user to add additional matters/financial accounts/class of transactions to the transaction service used by a particular user identity.

FIG. 1C is an exemplary graphical user interface 100C of a trusted transaction message that provides a bill pay history. Although FIG. 1C resembles aspects of FIG. 1B in that a bill paying transaction is presented in a trusted transaction mail message, GUI 100C illustrates that the trusted transaction mail message may present information related to an account of interest, in addition to presenting information related to a transaction with a third party.

GUI 100C is a trusted transaction mail message with a trusted sender 110C, a reserved header 120C, a reserved wallpaper 130C, and a bill pay history 140C. The trusted sender 110C, the reserved header 120C, and the reserved wallpaper 130C feature a sender identity, header, and wallpaper exclusively reserved for authenticated trusted transaction messages. Thus, senders without the permission of the intermediary host are precluded from using the trusted sender 110C, the reserved header 120C, and the reserved wallpaper 130C.

The bill pay history 140C illustrates monthly account activity from January 2003 to July 2003. The bill pay history 140C also allows a particular bill from BankOne Visa to be paid by interacting with a “Go Pay Bill” link (e.g., an execution button). Bill pay history 140C illustrates that information other than transaction information may be presented in a trusted transaction mail message.

In one implementation, GUIs 100B and 100C are rendered as a result of receiving the trusted transaction mail message depicted by the financial icon 110A shown in FIG. 1A. In another implementation, GUIs 100B and 100C are authenticated and/or generated independently (e.g., upon receipt of a user request to authentication a financial icon appearing in an inbox).

FIG. 1D illustrates an exemplary graphical user interface 100D (GUI 100D) of a confirmation message provided in response to the user selecting a triggerable execution button (e.g., the ‘Go Pay Bill 150B in FIG. 1B) in order to execute a financial transaction. In particular, GUI 100D informs the user that a financial transaction generated by a intermediary host has been executed. By confirming execution of a transaction, the intermediary host reduces interaction to confirm that a transaction was in fact executed. As shown, GUI 100D illustrates that the Visa transaction shown in FIG. 1B was executed, and that $18 (the minimum payment) was provided. Additionally, an indication could be provided explicitly indicating that the amount paid was a minimum payment (or full/maximum payment if appropriate). Moreover, other information may be provided to the user in the FIG. 1D interface, or on a buddy list as described by FIG. 10, such as the identity information for the account used to make a payment, tracking information for the transaction, or a triggerable control to dispute one or more aspects of the charge.

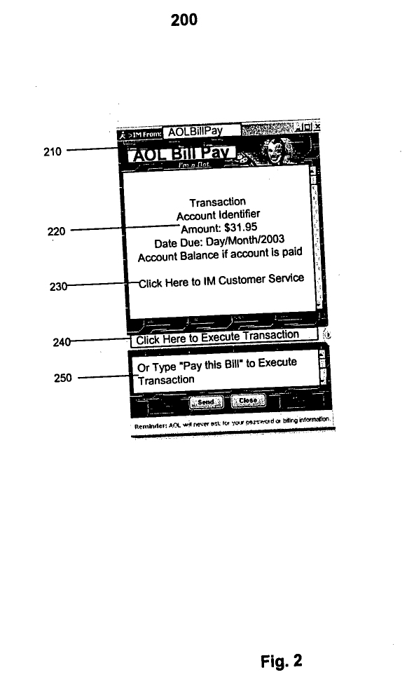

FIG. 2 illustrates an exemplary GUI 200 for a trusted instant message. GUI 200 includes a reserved header 210, a transaction description 220, a customer service label 230, an execute transaction button 240, and a text entry field 250.

The reserved header 210 includes graphical and textual information used to indicate the trusted status of the instant message. In particular, the reserved header 210 shows a reserved header (e.g., >IM from AOLBillPay), a reserved wall paper (the circuitry wallpaper), and a reserved header (e.g., “AOL Bill Pay—I'm a BOT”). In one implementation, the instant message includes the trusted graphics and text that provide the reserved appearance. The reserved appearance may include a chrome appearance. The reserved appearance may share similarities with other reserved portions in other trusted transaction messages (e.g., financial icon 110A, reserved header 110B, reserved background 120B, reserved header 120C, and reserved wallpaper 130C all may use a similar chrome pattern, color, and/or motif). In another implementation, instant messaging software on a client is configured to present the instant message as a trusted instant message by determining or authenticating a sender of the instant message as a trusted sender (e.g., AOL Bill Pay). Still, another implementation may include a configuration where trusted labels describing the trusted status of the instant message are received separately from an intermediary host.

The transaction description 220 includes a description of a proposed transaction. In GUI 200, the transaction description 220 includes the account identifier (e.g., the bank account that will be debited), a transaction amount ($31.95), a date due, and an account balance.

The customer service label 230 includes a customer service code segment configured to request customer service for the account of interest. For example, a user may select or click on the customer service label 230 to learn additional information about the billing party in the proposed transaction. Interfacing with the customer service label may generate a trusted instant message to a customer service center where one or more customer service representatives may use instant messaging or other communications software to correspond with the user. In another example, the user may report the proposed transaction as suspicious activity. The proposed transaction may be identified as being suspicious based on comparisons to established threshold criteria, e.g., because the amount of the transaction may be unusually large (or different), the location or originating point of the transaction may be flagged as being associated with an unusual level of fraudulent activity, the type of goods or services purchased in a transaction do not correlate to a user's demographic profile, the time of the transaction may be unusual, and/or the relationship between the transaction and other transactions may be suspicious (e.g., two monthly mortgages being generated two days apart may be suspicious).

The execute transaction button 240 triggers an execution code segment configured to execute the proposed transaction when the user interfaces with the execute transaction button 240.

Alternatively, the user may use the text entry field 250 to execute the transaction by typing, “pay this bill” in the text entry field 250. The text entry field 250 also may enable a user to access a menu of account options to retrieve additional information, or perform other operations such as request customer service.

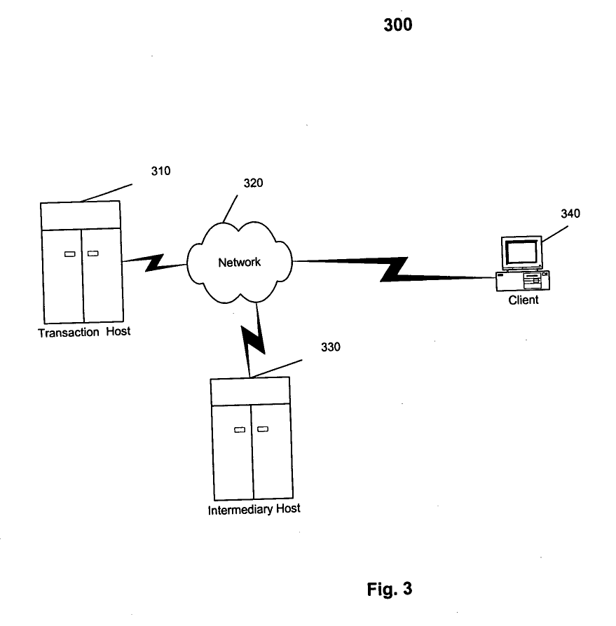

FIG. 3 illustrates an exemplary block diagram of a communications system 300 configured to enable transactions using authenticated messaging. In particular, a transaction host 310 may generate transaction information that is sent through the network 320 to the intermediary host 330. The intermediary host 330 is configured to structure the transaction information as a trusted transaction message that is transmitted to the client 340. The client 140 is configured to receive the trusted transaction message so that a user may interface with the trusted transaction message to execute the transaction.

Generally, each of the systems shown in communications system 300, such as the transaction host 310, the intermediary host 330, and the client 340 may be implemented by computer systems configured to executed instructions in a predetermined manner. Moreover, each of these systems may be implemented by, for example, a general-purpose computer capable of responding to and executing instructions in a defined manner, a personal computer, a special-purpose computer, a workstation, a server, a device, a component, other equipment or some combination thereof capable of responding to and executing instructions. These systems may be structured and arranged to receive instructions from, for example, a software application, a program, a piece of code, a device, a computer, a computer system, or a combination thereof, which independently or collectively direct operations, as described herein. The instructions may be embodied permanently or temporarily in any type of machine, component, equipment, storage medium, or propagated signal that is capable of being delivered to these systems.

The transaction host 310 includes a device configured to provide transaction information. For example, the transaction host 310 may be configured to provide bills for a financial transaction, allocate resources or inventory for an inventory management system, or execute trades in a trading system.

In one implementation, the transaction host 310 is configured to aggregate multiple transactions from a single bank or vender, or from several different banks or vendors. The different transactions may be processed so that the transactions are presented in a transaction feed conforming to a specified standard, protocol, or format. In another implementation, a bank or other financial institution operates the transaction host 310.

The transaction host 310 may be configured to transmit the transaction information as the transaction information is received and processed. For example, the transaction host 310 may maintain an active connection to the intermediary host 330 and transmit transaction information across the active connection as the transaction information is being generated. Alternatively, the transaction host 310 may combine multiple transactions in a file and periodically exchange the file with the transaction intermediary 330.

The transaction host 310 may include a messaging device configured to generate instructions to transmit electronic mail messages. For example, the transmitting host 310 may generate a message relating to a bill payment service in a messaging application and transmit the message using the network 320 to intermediary host 330 using SMTP (“Simple Mail Transfer Protocol”) packets.

The transaction host 310 may be configured to present transaction information using one or more messaging applications. For example, the transaction host 310 may provide the transaction information in the form of an electronic mail message. Alternatively, the transaction host 310 may send other forms of messages such as instant messaging, secure messaging, or other messaging formats and/or protocols.

The network 320 includes hardware and/or software capable of enabling direct or indirect communications between the transaction host 310, the intermediary host 330, and the client 340. As such, the network 320 may include a direct link between these systems, or it may include one or more networks or subnetworks between them (not shown). Each network or subnetwork may include, for example, a wired or wireless data pathway capable of carrying and receiving data. Examples of the delivery network include the Internet, the World Wide Web, a WAN (“Wide Area Network”), a LAN (“Local Area Network”), analog or digital wired and wireless telephone networks, radio, television, cable, satellite, and/or any other delivery mechanism for carrying data.

Although the network 320 is shown as a common network used by the transaction host 310, the intermediary host 330, and the client 340, separate and distinct networks and network types may be used to interface these systems. For example, a financial network using proprietary protocols across private links may be used to connect the transaction host 310 with the intermediary host 330, while the intermediary host 330 may interface with the client 340 through an IP network.

Generally, the intermediary host 330 includes a system configured to receive transaction information from a transaction host 310 and transmit trusted transaction messages based on the transaction information to the client 340. More particularly, the intermediary host 330 is configured to perform one or more authentication operations on the transaction information, package the transaction information in a transaction, and generate a trusted transaction message, where the trusted transaction message indicates that the trusted transaction message has been authenticated and, where appropriate, enables a user to execute the transaction when the recipient interacts with the transaction.

The intermediary host 330 includes a communications interface configured to receive transaction information from the transaction host 310. In one example, the communications interface is configured to receive a transaction feed of continuous transaction information. In another example, the communications interface periodically receives a file provided by the transaction host 310.

The intermediary host 330 may be configured to verify that the transaction information provided by the transaction host 310 conforms to a format, protocol, or specification. For instance, the transaction host 310 and the intermediary host 330 may agree to exchange transaction information using a banking protocol across dedicated financial circuits. The intermediary host 330 may be configured to parse the transaction information to confirm that the transaction information conforms to the agreed upon banking protocol.

The intermediary host 330 may include one or more security systems or code segments configured to perform security and authentication operations in support of a messaging-based transaction system. In one implementation, the intermediary host 330 includes an encryption module configured to maintain secure communications between the transaction host 310 and the intermediary host 330. In another implementation, the intermediary host 310 includes a code segment configured to interface with a trusted directory server used to validate sender information for the transaction host 310. Similarly, the intermediary host 330 may include a code segment configured to validate transaction information. For instance, the intermediary host 330 may reference a permissions list for a user and determine whether a proposed transaction is allowed in the permissions list.

The intermediary host 330 may include a code segment configured to package a transaction. For example, a code segment included on the intermediary host 330 may parse a transaction feed, extract individual transactions from the transaction feed, and package the individual transactions so that a user may execute the individual transaction. In one instance, the individual transaction may relate to a proposed bill payment operation. Upon identifying the individual transaction, the intermediary host 330 may load an executable code segment to a server. The executable code segment may be configured to execute when the user accesses the transaction in a trusted transaction message, which in turn references the server to execute the executable code segment. Executing the executable code segment may transfer resources between different accounts.

The intermediary host 330 includes a messaging application configured to generate a trusted transaction message that includes the transaction. In one implementation, the intermediary host 330 is configured to generate and transmit trusted instant messages in an instant messaging system. In another example, the intermediary host 330 is configured to generate and transmit trusted transaction mail messages in an electronic mail messaging system.

Regardless of the underlying messaging platform (e.g., electronic mail messaging or instant messaging), the intermediary host 330 is configured to generate a trusted transaction message that indicates the authenticated status of the trusted transaction message so that the user may interact with the transaction in the trusted transaction message to execute the transaction. For instance, the intermediary host 330 may include a code segment that inserts a reserved header, wallpaper, and sender information in the trusted transaction message. The intermediary host 330 may be configured to reserve the reserved appearance (e.g., reserved header) exclusively for trusted transaction messages and stop (e.g., filter) other messages from presenting the reserved appearance.

In one implementation, the intermediary host 330 is configured to indicate the trusted status by providing the trusted icon, header, wallpaper or sender in the trusted transaction message itself. Thus, the intermediary host 330 may be configured to embed a reserved image in an electronic mail message itself. In another implementation, the intermediary host 330 is configured to indicate the trusted status separate from the trusted transaction message. The intermediary host 330 may instruct the client 310 to present instant messages from a particular sender as a trusted instant message, or that a particular electronic mail message is a trusted transaction mail message. The intermediary host 330 may be configured to indicate the trusted status in communications external to or accompanying the message.

The client 340 may include one or more messaging applications that allow a user to operate an electronic mailbox used to administer a system for sending and receiving electronic mail messages. Examples of the messaging applications may include a messaging application integrated into an online service provider client such as the AOL client. Other examples of the messaging application may include a web browser configured to enable access to an electronic mailbox accessible through a web server, or a messaging application running in a generic operating system (e.g., Microsoft Outlook) or server (e.g., Exchange server). Other forms of messaging supported on the client may include an instant messaging application (e.g., AOL Instant Messenger) or a proprietary messaging application.

Although many of the operations are described where the intermediary host 330 receives transactions and messages before enabling a client 340 to access a trusted transaction message, other configurations may allow direct communications between the transaction host 310 and the client 340. For instance, client 340 may receive a message directly from a transaction host 310. The client 340 then may poll an intermediary host 340 to authenticate the message and/or package the message as a trusted transaction message (e.g., by repackaging the message with a transaction that the user may interact with to execute).

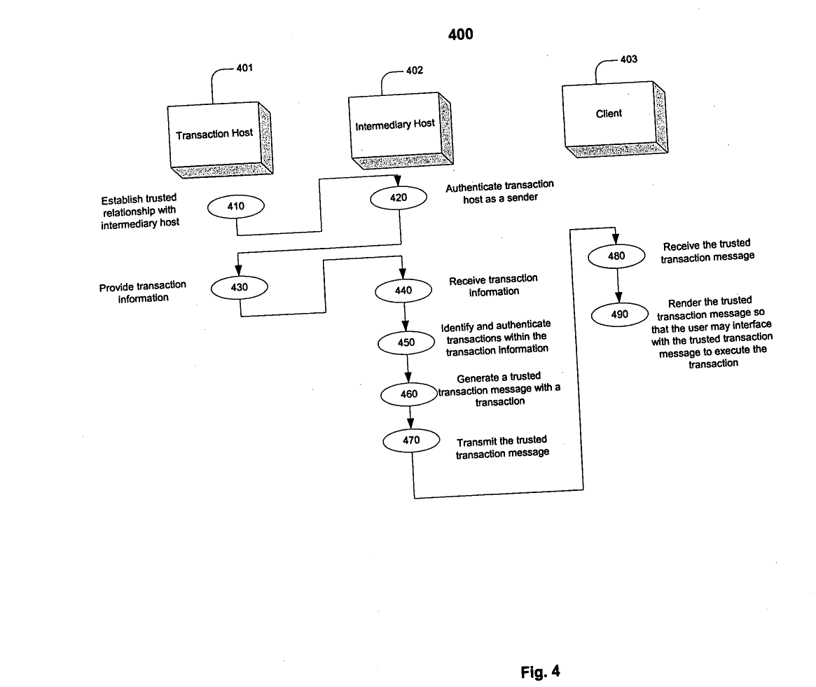

FIG. 4 is a flow chart 400 of an exemplary process by which a client 403 receives a trusted transaction message from a transaction host 401 using an intermediary host 402. For ease of discussion, particular components described with respect to FIG. 3 are referenced as performing the operations shown in flow chart 400. However, similar methodologies may be applied in other implementations where different components are used to define the structure of the system, or where the functionality is distributed differently among the components shown by FIG. 3.

The transaction host 401 optionally establishes a trusted relationship with the intermediary host 402 (410), and the intermediary host 402 authenticates the transaction host as a sender (420). Generally, establishing a trusted relationship includes performing one or more operations to establish confidence that the transaction host 401 and the intermediary host 402 can exchange sensitive information used in a messaging-based transaction system. In one example, establishing a trusted relationship includes verifying the identity of the systems (e.g., the transaction host 401 and/or the intermediary host 402) in the transaction. Verifying the sender may include verifying an IP address, a domain name, a system/user account and/or other information that distinguishes trusted systems from untrusted systems. In another example, establishing the trusted relationship may include using a challenge-and-response authentication system. In the challenge-and-response system, the transaction host 401 and the intermediary host 402 challenge each other for one or more security parameters (e.g., a password, a key, a hash result, a digital signature, or a transaction label) that are verified before a trusted relationship can be established. Yet another example of establishing a trusted relationship includes performing a key exchange that is used to establish an encrypted communications session between the transaction host 401 and the intermediary host 402. Still another example relies on using reserved circuits, paths, ports (e.g., a Transport Control Protocol port number), or interfaces (physical or virtual (e.g., a VPN (Virtual Private Network)) for establishing a trusted relationship.

The transaction host 401 provides transaction information to the intermediary host 402 (430), which in turn receives the transaction information (440). Generally, providing the transaction information includes providing information describing or accounting for the state or transfer of resources (e.g., goods, services, or funds). For example, the intermediary host 402 may provide information descriptive of one or more customer purchases enabling generation of a bill. More particularly, providing the transaction information may include providing information descriptive of a banking customer's financial activities so that a bill may be paid. In another example, providing the transaction information includes providing inventory management information.

Providing transaction information may include providing transaction information in varying degrees of structure, organization, and size. In one example, the transaction host 401 provides the transaction information as a transaction feed with multiple transactions for multiple users/accounts in the transaction feed. In another example, the transaction host 401 provides the transaction information as a message addressed to a particular recipient.

The intermediary host 401 identifies and optionally authenticates transactions from within the transaction information (450). Generally, identifying transactions from within the transaction information includes analyzing the transaction information and identifying an exchange or description of interest to one or more specified parties. In a first example, identifying the transactions within the transaction information includes parsing individual transactions from a transaction feed relating to multiple accounts. Parsing the individual transactions may include reading a file provided by a bank acting as a transaction host 401, identifying transactions within the file, and identifying a user, organization, or account for each of the transactions.

In some implementations, authenticating the sender is sufficient to generate a trusted transaction message. In other implementations, information in the transaction is authenticated. For example, a transaction may be authenticated because the transaction appears on an expected date for an expected amount. Other transaction parameters used to authenticate the transaction may include, but are not limited to, use of (1) biller identity and address, (2) a type of good or service, (3) a transaction location, (4) a transaction gateway (e.g., use a particular credit card or identification card), and/or (5) use of a assurance device (e.g., presence of a PIN or biometric data).

Identifying the transaction may include augmenting the transaction information by retrieving additional information from sources external to a primary source of transaction information. For example, the transaction information may include a name and an address. The intermediary host 402 may correlate the name and the address with messaging information (e.g., a screen name or an electronic mail address). The intermediary host 402 then adds the messaging information to the transaction information. In another example, the intermediary host 402 receives transaction information descriptive of a purchase and augments the transaction with information enabling a bank account or a credit card to be debited.

The intermediary host 402 generates a trusted transaction message with a transaction addressed to the client (460). Generating the trusted transaction message includes packaging a message indicating an authenticated status in a manner enabling the user to interact with the trusted transaction message to execute the transaction. For example, the intermediary host 402 may generate a trusted transaction mail message (e.g., a type of electronic mail message) with an embedded program. The trusted transaction mail message may describe a transaction (e.g., a request to pay a bill electronically) and enable execution of the embedded program when a user selects the embedded program providing the authorization to execute the transaction.

Generating a trusted transaction message also may include generating a transaction. For example, the transaction information provided by the transaction host 401 may include a creditor identity, a customer identity and address, a bill amount, and a description of the transaction. To the extent that this lack of information is not sufficient to execute a transaction, or more precisely, to transfer resources from a user to the creditor, transaction information may be linked to financial information established for the user so that resources may be transferred when the user elects to execute the transaction.

In one example, relating the transaction information to the user's financial information includes associating electronic funds transfer information for a user's bank so that the user's bank account is used to pay a bill. In another example, relating the transaction information with the user's financial information includes linking the transaction information with a credit line or credit card account established by the user with the intermediary host. This may include a user providing a credit card to pay a recurring bill and incidental expenses for an online service provider, linking a credit card with an electronic wallet maintained by an online service provider, and/or using a line of credit established with the messaging service provider.

Regardless of the format of the transaction information or the financial information, generating a transaction creates a pending instrument configured to satisfy a bill related to the transaction information using the user's financial information. The transaction is pending in that the instrument is stored and awaits user input to execute the transaction. A reference to the stored transaction is provided in a trusted transaction message so that the user may interact with the trusted transaction to execute the stored transaction (e.g., by selecting a “Go Pay Bill” button linked to the stored transaction).

The intermediary host 402 transmits the trusted transaction message to the client 403 (470), which in turn, receives the trusted transaction message (480). The client 403 renders the trusted transaction message in a manner indicating the authenticated status and so that a user may interact with the trusted transaction message to execute the transaction (490). For example, when the intermediary host 402 sends the trusted transaction message as a trusted transaction mail message, the trusted transaction mail message may appear in an inbox similar to the example shown in FIG. 1. When a user accesses the trusted transaction mail message, a user interface may be presented, e.g., similar to the user interface shown in FIG. 2. In particular, the “Go Pay Bill” button 250 may be selected to execute the transaction. Selecting the “Go Pay Bill” button may access a stored transaction in a manner that executes the stored transaction. For example, the “Go Pay Bill” Button may correspond to and trigger execution of a code segment residing on the intermediary host 402. When the client 403 selects the “Go Pay Bill” button, the client 402 may be configured provide a transaction identifier in a secure manner to the execution code segment. The execution code segment in turn executes the transaction identified by the transaction identifier. Alternatively, the “Go Pay Bill” button may link to the actual stored transaction. Accessing the actual stored transaction by pressing the “Go Pay Bill” button may trigger immediate execution of the transaction.

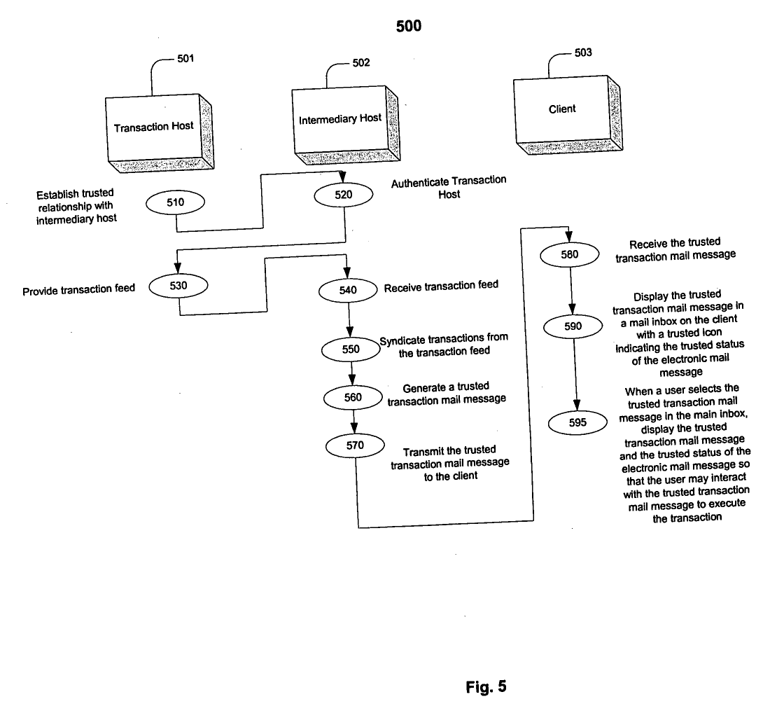

FIG. 5 is a flow chart 500 of another exemplary process by which a client 503 receives a trusted transaction message in the form of an electronic mail message, that is, a trusted transaction mail message. While some of the operations shown in flow chart 500 may be similar to flow chart 400, flow chart 500 illustrates how a transaction host 501 provides a transaction feed with multiple transactions. The transaction feed is syndicated and used to generate trusted transaction messages. For ease of discussion, particular components described with respect to FIG. 3 are referenced as performing the operations shown in flow chart 500. However, similar methodologies may be applied in other implementations where different components are used to define the structure of the system, or where the functionality is distributed differently among the components shown by FIG. 3.

The host 501 establishes a trusted relationship with the intermediary host 502 (510). The intermediary host 502 authenticates the transaction host 501 (520). The transaction host 501 provides the transaction feed (530). Generally, providing the transaction feed indicates that multiple transactions are being provided in one communications session or transmission. For example, the transaction host 501 may aggregate transactions from one source or multiple sources for one or multiple users/accounts/organizations. This may include receiving bills from different vendors, credit card companies, and banks. The transaction host 501 may combine the received bills, format the different bills into a specified format, and combine the bills into a file or transaction feed. The transaction host 501 then periodically (e.g., at scheduled intervals defined by the user, source or host), intermittently, or continuously provides transaction feed to the intermediary host 502.

In one example, the transaction host 501 provides the transaction feed as the transaction information is received and processed (e.g., real-time). In another example, the intermediary host 502 provides the transaction feed on a scheduled basis, or every specified number of transactions.

The transaction host 501 may optionally provide the transaction feed through a trusted communications channel (530). The transaction host 501 uses the trusted communications channel to protect the contents of the transaction feed and to indicate the authenticated status of the transaction information in the transaction feed. Note that additional authentication may be performed. For example, the transaction host 501 may establish an encrypted communications session with the intermediary host 502 across dedicated transaction circuits using a trusted transaction communications protocol in a first authentication operation, and then verify that the transaction format conforms to a specified format in a second authentication operation.

The intermediary host 501 receives (540) and syndicates transactions from the transaction feed (550). Syndicating transactions from the transaction feed includes structuring individual transactions from a transaction feed with multiple transactions. For example, the intermediary host 501 may recognize a header or a delimited format to indicate boundaries between individual transactions.

The intermediary host 502 generates a trusted transaction mail message addressed to the client 503, or addressed to a user accessing the client 503 (560) with the transaction and indicating the trusted status of the trusted transaction mail message so that a user may interact with the trusted transaction mail message to execute the transaction within. The intermediary host 502 transmits the trusted transaction mail message to the client 503 (570). The client 503 receives the trusted transaction mail message indicating the trusted status of the trusted transaction mail message (580). The client 503 displays the trusted transaction mail message in a mail inbox on the client with a trusted icon indicating the trusted status of the trusted transaction mail message (590). When a user selects the trusted transaction mail message in the inbox, an trusted transaction mail message and the trusted status of the trusted transaction mail message are displayed so that a user may interact with the trusted transaction mail message to execute the transaction (595).

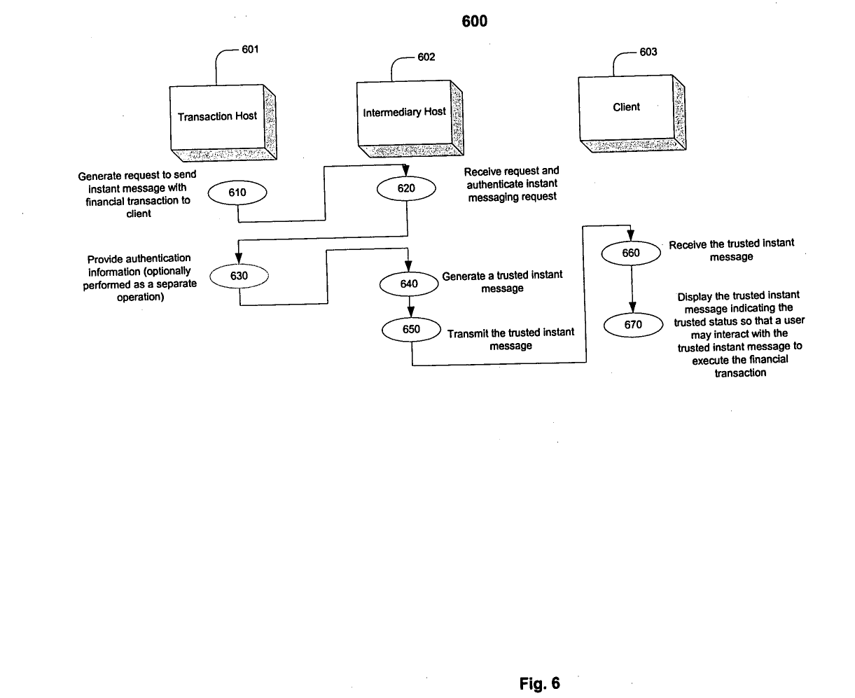

FIG. 6 is a flow chart 600 of an exemplary process by which a client 603 receives a trusted transaction message in the form of a trusted instant message. For ease of discussion, particular components described with respect to FIG. 3 are referenced as performing the operations shown in flow chart 600. However, similar methodologies may be applied in other implementations where different components are used to define the structure of the system, or where the functionality is distributed differently among the components shown by FIG. 3.

The transaction host 601 generates a request to send an instant message with a financial transaction to the client 603 (610). In one example, generating the request includes sending an instant message to the intermediary host 602 and requesting the intermediary host 602 processes the instant message as a trusted instant message. In another example, generating the request includes generating a request that a user receive timely notification of a transaction or event but does not specify the format of the notification. Rather, the transaction host 601 allows the intermediary host 602 to determine that the transaction information be sent by SMS (Short Message Service), trusted transaction mail, or trusted instant messaging.

The intermediary host 602 receives the request and authenticates the instant message request (620). The transaction host 601 optionally may provide additional authentication information (630). For example, the transaction host 601 may initially request the availability of the intermediary host 602 to transmit instant messages. When the intermediary host 602 indicates that the intermediary host 602 supports a trusted instant messaging capability, the transaction host 601 may provide additional authentication information, such as authentication information related to a particular transaction, user, or account.

The intermediary host 602 generates a trusted instant message (640). Generating the trusted instant message includes receiving transaction information and packaging a transaction in the instant message so that the user may interact with the transaction in the instant message to execute the transaction. Generating the trusted instant message may include retrieving transaction information from sources other than the transaction host 601 generating the request. For example, the transaction host 601 may request that the intermediary host 602 send a trusted instant message to a first user that includes a specified transaction number. The intermediary host 602 may retrieve the specific transaction referenced by the transaction number from a data store and include the transaction in the trusted instant message. In another example, the intermediary host 602 retrieves financial information from a user account server so that a user's credit card is debited when the user interacts with the transaction in the trusted instant message.

The intermediary host 602 transmits the trusted instant message to the client 603 (650), which receives the trusted instant message (660). The client displays the trusted instant message indicating the trusted status so that a user may interact with the trusted instant message to execute the transaction (670). In one example, the financial transaction is executed by interacting with a button within the instant message. In another example, the transaction is executed when the user types a response in reply to the trusted instant message. For instance, a user may respond in a text portion of the trusted instant message (e.g., by typing ‘accept’ after when prompted to enter ‘accept’ to execute the transaction), or click on an HTML (“Hyper Text Markup Language”) link appearing within the instant message.

Alternatively, the user may alter the terms of the transaction. For example, rather than pay a monthly minimum to a balance on a credit card, a user may elect to pay down the outstanding balance by specifying a different amount in a form sent in the trusted instant message.

Although some of the operations shown in flow charts 400, 500, and 600 describe generating a trusted transaction message, other operations may performed pursuant to enabling a messaging-based transaction system. For example, a message not deemed a trusted transaction message may be supplemented with information so as to become a trusted transaction message. For instance, an electronic mail message may be retrieved by a client. Upon determining that the message may be used as the basis for a trusted transaction message, the client may interface with other systems (e.g., an intermediary host) so that the message becomes a trusted transaction message. Thus, a client may analyze the sender and determine that the message is from a biller, access a billing host to retrieve transaction information, supplement the content of the message with a description of a transaction and a triggerable transaction code segment, and render the message using the format reserved for trusted transaction messages. In this manner, the trusted status is determined, derived, and presented after delivery of a message rather than before, in response to a user request or selection or otherwise.

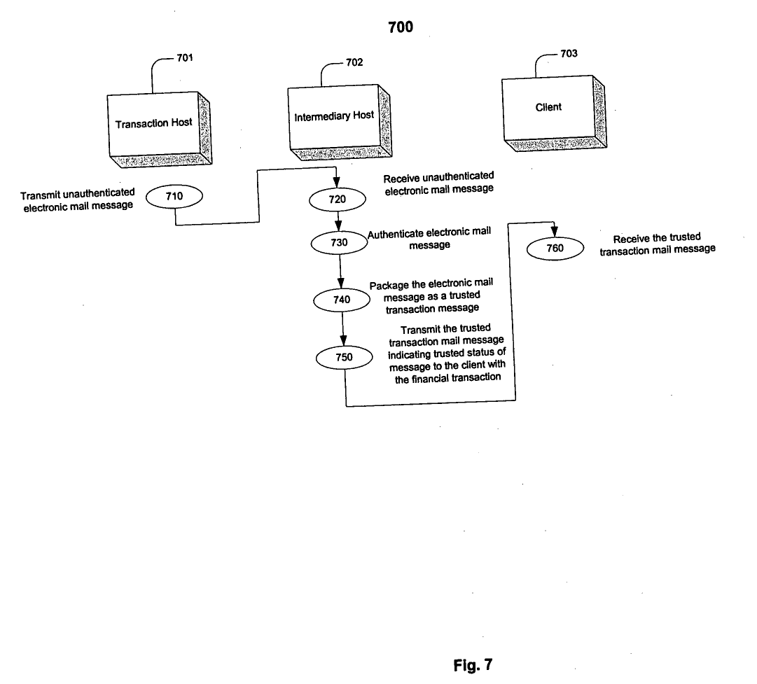

FIG. 7 is a flow chart 700 of an exemplary process by which an intermediary host 702 may receive an unauthenticated electronic mail message, authenticate the unauthenticated electronic mail message, and forward the electronic mail message as a trusted transaction mail message. However, similar methodologies may be applied in other implementations where different components are used to define the structure of the system, or where the functionality is distributed differently among the components such as those shown by FIG. 7.

The transaction host 701 transmits an unauthenticated electronic mail message to the intermediary host 702 (710). For example, a bank operating a transaction host 701 may send an electronic mail message (e.g., using SMTP) requesting that a bank customer pay a bill. In one example, the transaction host 701 includes the transaction in the electronic mail message. In another example, the transaction host 701 includes a label referencing the transaction where the label relates to a transaction stored on a label transaction server operated by the bank. In this example, the label transaction server is configured to authenticate a device requesting the label, and provide the transaction to authenticated parties so that the label may be included in a trusted transaction message addressed to a user.

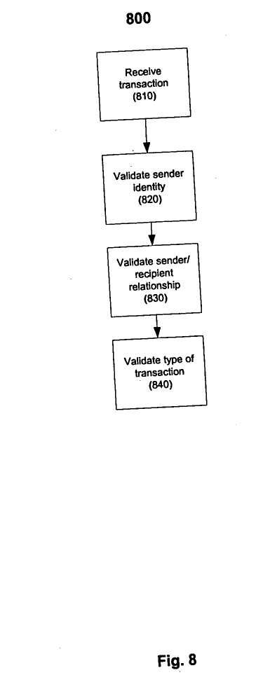

The intermediary host receives the unauthenticated electronic mail message (720), and authenticates the electronic mail message (730). Typically, the electronic mail message may be authenticated using the exemplary operations described with respect to FIG. 8. For example, the sender's identity may be validated, the transaction may be analyzed, and/or the sender/recipient relationship may be validated. After authenticating the electronic mail message, the intermediary host 702 packages the electronic mail message as a trusted transaction message (740). For example, the intermediary host 702 may package the electronic mail message with additional information to be used in the blue field and/or in the header (e.g., a reserved header, or wallpaper). In one example, the intermediary host 702 packages the trusted transaction mail message with information indicative or the importance to the recipient, the degree of authentication, the nature of the proposed transaction and/or the relationship between the sender and the recipient. For example, a first icon or format may be used to indicate a transaction related to a mortgage payment (of high importance). In another example, a second icon may be used to specify that the trusted transaction mail message includes a request to enroll a new party in a bill paying service offered by the intermediary host 702.

The intermediary host 702 transmits the trusted transaction mail message (750), which the client 703 then receives (760).

The operations shown in flow chart 700 may be particularly applicable to processing solicitations from partners with which minimal or no prior relationship exists between the sender and the recipient. Similarly, by packaging the trusted transaction mail message with information indicative of the nature of the transaction, the user may better appreciate the particular significance of the message that has been received.

FIG. 8 is a flow chart 800 of an exemplary process by which an intermediary host authenticates a transaction for use in a trusted transaction message. Generally, the operations shown in FIG. 8 may be performed on an intermediary host. Initially, the intermediary host receives the transaction (810). In one example, receiving the transaction may include receiving a complete transaction directly from the transaction host. In another example, receiving the transaction includes receiving transaction information and augmenting the transaction information from other sources.

The sender identity is validated (820). Validating the sender identity may include determining that the actual sender is a designated authority, account, or sending system. In one example, the sender identity is validated by comparing sender information (e.g., a sender IP address) with published information for the sender (e.g., an IP address for the sender). Several financial institutions may participate in a certified directory system where reference information for each of the financial institutions is published. In another example, the identity of a system account is validated. Still, other examples may include validating a sender domain name, or a sender screen name.

The sender identity/recipient relationship is validated (830). For example, although an intermediary host may have relationships with multiple financial institutions, a particular user may only be affiliated with a certain bank. In one example, validating the sender identity/recipient relationship is performed by comparing a sender identity for a pending transaction (that is with a proposed transaction that has not been authenticated) with a list of organizations with which the recipient indicates a relationship exists. A user may designate which vendors and financing sources the user has a relationship. When the sender identity is not found in the list of organizations, the transaction request may be rejected, or the user may be prompted to specify whether a relationship exists with the requesting sender. The user may add the requesting sender to the list of organizations by responding to the prompt and indicating that the requesting sender should be added to the list of recipients.

The intermediary host validates the type of transaction (840). Generally, validating the type of transaction includes determining whether the pending transaction is of the form, scope, or nature associated with the recipient. In one example, the intermediary host may analyze whether the pending transaction relates to a type of transaction that the user will accept. For example, the user may elect to participate in a bill paying system for transactions for paying household necessaries (e.g., a mortgage, utility bill, insurance) but elect not to participate in a bill paying system for Internet-commerce or discretionary expenditures such as consumer electronics. In another example, the user may elect to participate in a bill paying system for transactions under a specified limit but elect not to use the bill paying system for transactions above the specified limit.

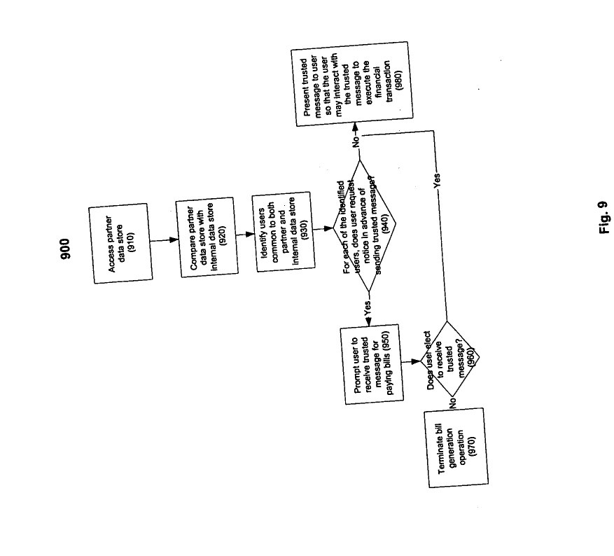

FIG. 9 is a flow chart 900 of an exemplary process by which an intermediary host may generate a trusted transaction message by interfacing with a partner. For ease of discussion, particular components described with respect to FIG. 3 are referenced as performing the operations shown in flow chart 900. However, similar methodologies may be applied in other implementations where different components are used to define the structure of the system, or where the functionality is distributed differently among the components shown by FIG. 3.

A partner data store is received (910). For example, an intermediary host may receive a database from a wireless carrier offering wireless phone services.

The partner data store is compared with the internal data store (920), and users (or organizations) common to both partner and internal data stores are identified (930). Typically, comparing the partner data store with the internal data store includes identifying accounts, users, organizations, or identities that are both associated with the intermediary host and the partner. For example, an online service provider operating an intermediary host may receive a database of customers for a wireless carrier. The intermediary host may identify customers using the online service provider and the wireless carrier. By identifying common customers, the intermediary host may proactively enroll customers in a messaging-based transaction system, or more particularly, a messaging-based bill payment service.

Identifying users common to both partner and internal data stores may include performing one or more operations to establish confidence that the common user (or record) is likely to be the same user in reality. For example, additional information such as phone numbers, addresses, names, occupation, and account information may be compared to establish confidence. In another example, an initial comparison may be performed to identify common users. When the initial comparison reveals that common records may relate to a common user with a degree of uncertainty (e.g., other parameters used to confirm are unavailable or inconclusive), the common records may be designated to undergo additional analysis. For example, the intermediary host may retrieve information from a larger data store, or forward the two records to an operator to review similarities between the two accounts and make a determination.

The intermediary host determines if the user requests notification in advance of sending a trusted transaction message (940). When the user requests advance notice, the intermediary host transmits a prompt (950) to the user to determine if the user would like to use trusted messaging to pay bills (960). For example, the intermediary host may send a trusted transaction mail message asking the user if they would like to enroll in a bill payment service. In another example, the intermediary host sends a trusted instant message asking if the user would like to pay a bill for the wireless carrier through a messaging-based bill payment service. If not, the bill generation operation is terminated (970). If so, the bill generation operation is processed indicating the user elects to participate in a messaging-based transaction system.

Whether the user does not request advance notification or elects to participate in the messaging-based transaction system after receiving such notification, a trusted transaction message is generated so that the user may interact with the trusted transaction message to execute the financial transaction (980).

The messaging-based transaction system may be accessible through a buddy list/instant messaging system. In one instance, a trusted buddy list icon is used to enter a transaction service (e.g., Bill Pay Home). The user may exchange trusted instant messages with the trusted screen name to execute transactions. In another instance, a particular type of transaction (e.g., a recurring bill) appears as a trusted buddy list icon in a buddy list. A user may interface with the trusted buddy list icon to retrieve the status of the particular transaction and/or execute a transaction using a trusted instant message.

For example, FIG. 10 illustrates an exemplary user interface (UI) 1000 of an instant messaging application configured to provide bill paying services. By enabling a user to execute transactions through an instant messaging interface, UI 1000 enables a user to use communication capabilities present in an instant messaging application to resolve questions and concerns that may arise while paying bills. UI 1000 includes a key 1010, an expandable grouping of bills with bill 1020 for a wireless phone bill, bill 1030 for a mortgage, bill 1040 for a credit card bill, bill 1050 for a utility bill, and bill 1060 for a newspaper bill. UI 1000 also includes a friends section 1070.

Typically, transactions appearing in UI 1000 will use a reserved appearance and structure similar to the reserved appearance and structure described with respect to FIGS. 1-9 and 11. In one implementation, the ability to enter and present bills is reserved to the trusted intermediary or a biller. The ‘bills’ tab may be hidden or selectively invoked so that sensitive financial information is protected. For instance, upon initial login, a buddy list icon of a miniature check or the Bills group identifier may be presented to indicate that transactions are awaiting user consideration. The user may select the buddy list icon and present login information in response to a prompt thus revealing or expanding the Bills group identifier to enable review and payment of the bills.

Key 1010 includes a description of the icon used to represent different states for a bill. For example, an ‘R’ represents a recurring bill, a ‘1’ represents a one-time bill, a ‘!’ represents a transaction that the user should review, and a ‘P’ represents a transaction that has been paid. Bills that arise periodically due to the ongoing nature of a transaction (e.g., a mortgage or a service contract for a wireless phone) may be identified as recurring so that user interaction may be reduced or eliminated in order to pay a bill. Thus, a bill may be automatically executed, or automatically executed after rendering the bill for a sufficient time to allow user review (e.g., a day or two). In another example, the user may select a ‘quick pay’ button that requires reduced user interaction in order to pay a bill. Furthermore, a profile for a recurring transaction may be derived so that bills conforming to a ‘normal’ profile are automatically paid or configured with a ‘quick pay’ button, while bills that do not conform to the profile are highlighted (e.g., with a ‘!’ or ‘please review’ icon) or configured to require more user involvement in order to execute the transaction.

Bill 1020 represents a recurring wireless phone bill for $110. Bill 1020 includes options that allow the bill to be paid, allow the user to upgrade the plan, and/or allow the user to upgrade the phone. The options for bill 1020 may be rendered automatically, or the options may represent part of a hierarchical display system so that the options are rendered in response to the user ‘expanding’ or interacting with a higher level icon.

Bill 1030 represents a mortgage of $1000 that has been paid. As shown, bill 1030 does not include options. Examples of options that may be displayed include a prepay option enabling the user to pay down the principal on a loan.

Bill 1040 represents a $150 credit card bill to be paid. The credit card includes an option to pay the bill, report fraud, or request customer service. The user may designate that customer service should be provided by email, a call to a home phone, a call to a Voice-over-Internet Protocol (VOIP) phone (e.g., a VOIP call to the instant messenger application), or by instant messenger. Requesting customer service may populate a communication transmitted to a customer service representative by providing information descriptive of the user, account, and/or transaction. In response to requesting customer service, a customer service request may be placed in a queue for processing. Information representing the anticipating response time may be rendered in the UI 1000. For example, if the user requests customer service be provided to a home phone number, the home phone option may be color coded to indicate the projected response time (e.g., red for more than 30 minutes, yellow for 10-20 minutes, and green for 0-10 minutes). Similarly, requesting customer service may change the status of the bill. For example, there may be a customer service charge for customer service provided to a home phone number. Requesting customer service may include designating a disputed status for one or more bills or items within a bill. Thus, a customer may pay most of the bill while a customer service representative investigates fraudulent behavior for particular charges appearing in the bill.

Bill 1050 represents a $300 utility bill that has flagged for user review. For example, the amount of the bill may differ significantly from past utility bills. A user may interact with bill 1050 so that bill 1050 receives a normal designation.

Bill 1060 represents a $30 nonrecurring newspaper bill. Exemplary options not shown may include a options provided by a billing party. For example, the user may expand the bill to reveal options enabling a user to place an advertisement, respond to an advertisement in the newspaper, report a local item of interest, report delivery problems, or write a letter to the editor.

Friends section 1070 includes buddy list icons for NAME_ONE and NAME_TWO. The buddy list icon may be configured to link an identity with a transaction. For example, if PERSON_NAME is a parent of NAME_ONE, and NAME_ONE may be responsible for $30 in overage fees, PERSON_NAME may link NAME_ONE to the bill. As a result NAME_ONE may be responsible for the overage fee, and PERSON_NAME may review whether NAME_ONE has paid $30 of the $110 bill. In one instance, linking is performed by selecting one or more identities and one or more bills. In another instance, a user identity or bill may be selected (e.g., with a right-mouse click) to reveal a menu of options. One of the options may allow the selected icon to be linked with a corresponding bill or user identity. In yet another instance, a trusted linking button may be provided that launched a series of prompts that configures a link. The resulting transfer of resources may be structured in a regulated manner so that the transfer complies with the laws and regulations and/or may be reviewed by a regulating authority to certify compliance with applicable regulations.

Although UI 1000 illustrates options generated by the billing party, other options and appearance information may be generated by a trusted intermediary. For example, ‘!’ or please review designation may be generated by a trusted intermediary that monitors account activity for discrepancies.

UI 1000 may be organized by transaction status. For example, a user may specify that suspicious transactions be presented first, unpaid bills be presented second, and paid bills be presented third. A due date for a bill may be specified in the buddy list user interface adjacent to one or more of the bills as could the last payment date.

FIG. 11 illustrates an exemplary UI 1100 configured to organize trusted transaction messages. In particular, UI 1100 illustrates a mail box that includes a ‘Bills’ tab configured to filter messages so that only trusted transaction messages are displayed. The status of the trusted transaction mail messages also is displayed. For example, UI 1100 includes trusted transaction mail messages with states described as unpaid, autopay, paid, or past due. The ‘Bills’ tab also includes transaction controls that may be used to process the trusted transaction mail message. For example, UI 1100 includes a ‘pay bill’ icon 1110, a ‘view bill details’ icon 1120, a ‘billing history’ icon 1130, and a preferences icon 1140.

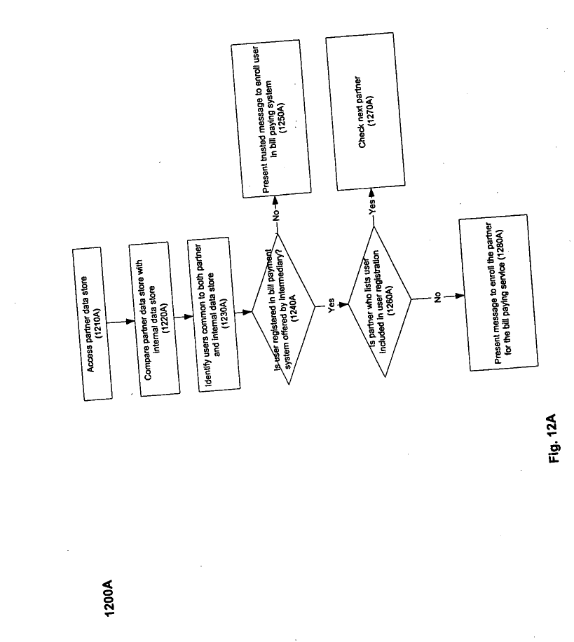

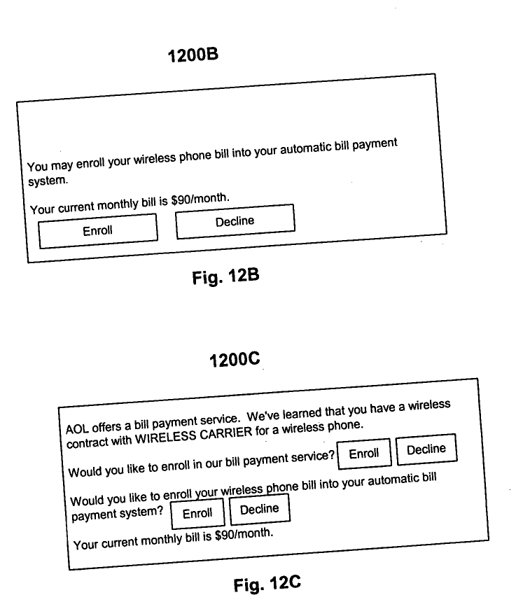

FIG. 12A is a flow chart 1200A of an exemplary process by which a user may be enrolled in a bill payment system so that financial transactions may be automatically generated and executed as a result of enrollment. While some of the operations shown in flow chart 1200A may be similar to other flow charts, and flow chart 900A in particular, flow chart 1200A illustrates how a user may be automatically enrolled in a bill payment service. Similar methodologies may be applied in other implementations where different components are used to define the structure of the system, or where the functionality is distributed differently among the components.

Initially, a partner data store is accessed (1210A), and the partner data store is compared with an internal data store (1220A). For example, an online service provider may interface with a wireless carrier offering wireless service plans. Users common to both partners and the internal data store are identified (1230A). For example, an online service provider may identify a unique user living at one address.

The intermediary host determines if the user is registered in a bill payment system offered by the intermediary (1240A). If not, a user is presented a trusted message to enroll in a bill payment system (1250A). The trusted message may explain that the intermediary offers a bill payment service. If the user elects to enroll, the user may provide account information to manage one or more bank accounts, electronic wallets, credits cards, or other financial instruments used to pay bills. Enrolling the user with a bill payment system configures the intermediary host to act on behalf of a user. In particular, enrolling in the bill payment system configures the intermediary host to receive transaction information directed to the user, associate the user's financial information with the transaction information, and package the financial information and transaction information as a transaction. Transactions then may be presented to the user for the user's consideration and execution.

If the user is registered in the bill payment system, the intermediary host determines whether the partner who lists the user is included in a user registration (1260A). Determining whether the partner already appears may be used to prevent redundant or duplicate partner enrollment. When the partner already is included in user registration, the enrollment process may be terminated for that user/partner combination, and a next partner may be checked for that user (1270A). Thus, the operation 120A may begin again for different partner. In one implementation, multiple partner data stores may be accessed and populated to the intermediary's internal data store to facilitate user registration and prepopulation/autopopulation of partners.

When the partner is not registered for that user, a trusted message may be presented to the user to enroll a bill from that partner in the user's bill payment system (1280A). By enrolling the bill from the partner into the user's bill payment system, the user instructs the intermediary host to generate transactions populated with transaction information from the partner (e.g., a bill) and financial information for the user. Thus, registering a bill for the user triggers a process on the intermediary host that configures the intermediary host to receive transaction information from the partner or for the partner's benefit. The intermediary host then is configured to associate the transaction information with one or more financial parameters for the user so that a transaction may be generated. The transaction then may be presented to the user in a trusted transaction message for consideration and execution.

FIG. 12B illustrates an exemplary user interface 1200B of a trusted message enabling an automatic bill payment customer to enroll another bill into the bill payment system. In particular, UI 1200B may be presented after the enrollment and registration operations shown in flow chart 1200A have been performed. UI 1200B enables the user to enroll a $90/month phone bill from a wireless carrier into a user's bill payment system.

FIG. 12C illustrates an exemplary user interface 1200C of a trusted message used by messaging service provider to enroll a user as a bill payment customer and also to enroll a bill into the bill payment system. UI 1200C may be similar to UI 1200B in that a user is allowed to enroll a wireless phone bill into an bill payment system. However, UI 1200C also illustrates how a user may be enrolled in a bill payment system in a manner also enabling perception of the opportunities available through the bill payment system, in this case payment of a wireless phone bill.

Other implementations are within the scope of the following claims. In one implementation, the trusted transaction mail message may be sent with a form in a trusted transaction mail message or a trusted instant message. The user may interact with the form to execute or modify the transaction.

In another implementation, the trusted transaction mail message may be sent with a button, control, or otherwise triggerable code segment to request different types of customer service. For instance, when the user receives a trusted transaction message, the user may select a “Report Fraud” button that generates a response. Selecting the “Report Fraud” button may restrict account activity and/or enable real-time communications with a human operator. For example, a VOIP (Voice over Internet Protocol) connection may be established with a call center so that the user may report suspicious activity. In another example, a notification is sent to a call center so that an operator in the call center may call the user on a telephone using a circuit-switched network or otherwise contact or communicate with the user.

Requesting customer service may generate a message to a customer service response organization that provides user information in the message. When a user requests customer service via an instant message, an intermediary host may automatically augment the instant message with user account information (e.g., full name, address, phone number, and account information) as well as a copy of a link to the message viewed by the user when the customer server request was made. Moreover, when the instant message relates to a particular transaction, the instant message may include information descriptive of the transaction (e.g., a transaction identifier and description).

The customer service identifier may appear as a common identifier to multiple users. For example, a screen name and a buddy list icon for BankOne customer service may appear as a trusted icon in an instant messaging buddy list (e.g., BankOneCustomerService). Different BankOne customers executing BankOne transactions may request customer service by sending an instant message to the common identifier (BankOneCustomerService). Although the same BankOneCustomerService screen name is used by both customers, the instant messaging sessions are operated and maintained independently so that a first customer service operator may maintain a first instant messaging session with a first user while a second customer service operator may maintain a second instant messaging session with a second user when both customers are exchanging separate customer service identifiers with the BankOneCustomerService screen name.

The trusted intermediary may enable different options to execute a transaction. In one example, a user is asked to complete a robust authentication sequence (e.g., complete a bilateral authentication sequence). Once the robust authentication sequence has been completed, enhanced-user conveniences predicated upon robust authentication may be offered. For example, a user may be challenged to provide sensitive information known only to the user or use a secure configuration (e.g., use a trusted or secure browser or a particular an authentication token). Upon completion of the challenge, the user may be provided with a ‘quick pay’ button in a trusted transaction message that the user may select to quickly execute a transaction. In another example, a user may be allowed to reply to a trusted transaction message in order to pay a bill.

In one implementation, separate organizations operate the transaction host and the intermediary host. For instance, a bank may operate the transaction host while an online service provider such as America Online, Inc. operates the intermediary host. The intermediary host may be configured to operate with other systems and services operated by the online service provider (e.g., directory services). In another implementation, the transaction host and the intermediary host are operated by the same organization. For instance, an organization such as a bank or an online service provider may offer both banking and messaging services.

Although many of the operations were described as being performed on the intermediary host, the operations also may be performed on other hosts and/or the client. For example, although the intermediary host was described as performing the authentication operations, the client also may perform one or more authentication operations.

1. A method of enabling messaging-based transactions, comprising:
accessing, from a trusted source, transaction parameters revealing at least a registrant identity, a transaction amount, and an identity for a creditor of the registrant;
accessing registered payment parameters associated with the registrant, including information related to a financial account designated by the registrant as available for application against payment requests;
generating a message reflecting at least the creditor and the transaction amount;
configuring the message to include a selectable object configured to trigger, upon selection by the registrant, a financial transfer of funds from the financial account to the trusted source in satisfaction of the transaction amount;
configuring the message to reflect a trusted status afforded to the trusted source; and
transmitting the message to the registrant such that the trusted status and selectable object are perceivable to the registrant, and such that the selectable object is accessible for selection by the registrant.

2. The method of claim 1 wherein accessing the transaction parameters includes accessing account information.

3. The method of claim 1 wherein accessing the transaction parameters includes accessing a date of a bill.

4. The method of claim 1 wherein accessing the transaction parameters includes a payment due.

5. The method of claim 1 wherein accessing the transaction parameters includes accessing an amount of a bill from the creditor.

6. The method of claim 1 wherein accessing the transaction parameters includes accessing a monthly payment amount due.

7. The method of claim 1 wherein accessing the transaction parameters includes accessing a full balance.

8. The method of claim 1 wherein accessing the transaction parameters includes accessing a screen name, a legal name, an identification number, or a social security number.

9. The method of claim 1 wherein accessing the transaction parameters includes authenticating the trusted source.

10. The method of claim 1 wherein accessing the transaction parameters includes authenticating the transaction parameters.

11. The method of claim 1 wherein the creditor is the trusted source.

12. The method of claim 1 wherein the creditor is an entity other than the trusted source.

13. The method of claim 1 wherein accessing registered payment parameters includes accessing the registered payment parameters prior to delivery of the message.

14. The method of claim 1 wherein accessing registered payment parameters includes accessing information related to a source of funds.

15. The method of claim 14 wherein accessing information related to the source of funds includes accessing account information.

16. The method of claim 14 wherein accessing information related to the source of funds includes accessing credit card information.

17. The method of claim 14 wherein accessing information related to the source of funds includes accessing an electronic wallet.

18. The method of claim 1 wherein generating the message includes generating the message accessible through a messaging application.

19. The method of claim 1 wherein generating the message includes generating the message outside of an Internet web browser.

20. The method of claim 1 wherein accessing transaction parameters includes generating accessing transaction parameters outside of the context in which a debt was incurred.

21. The method of claim 1 wherein configuring the message includes providing an option to enable the registrant to select from among more than one financial account to transfer funds to the creditor.

22. The method of claim 1 wherein configuring the message includes providing an option that enables the registrant to specify a payment amount.

23. The method of claim 1 wherein configuring the message includes providing an option that enables the registrant to specify payment in full.

24. The method of claim 1 wherein configuring the message includes providing an option that enables the registrant to specify payment of a minimum balance.

25. A method for enabling messaging-based transactions, the method comprising:
using an intermediary host to receive financial transaction information from a sender;
packaging the financial transaction information as a transaction when the financial transaction information can be authenticated;
generating a trusted transaction message configured to indicate to a recipient that the trusted transaction message has been authenticated, wherein the trusted transaction message is configured to execute the transaction in response to recipient interaction with the transaction in the trusted transaction message; and
transmitting the trusted transaction message.

26. The method of claim 25 wherein using the intermediary host to receive the financial transaction information from the sender includes receiving a transaction feed related to multiple accounts and multiple events from a transaction host.

27. The method of claim 25 wherein using the intermediary host to receive the financial transaction information from the sender includes receiving an electronic mail message.

28. The method of claim 25 wherein using the intermediary host to receive the financial transaction information from the sender includes receiving a request to transmit a trusted transaction message with the financial transaction information to the recipient.

29. The method of claim 25 wherein authenticating the financial transaction information includes comparing sender information with authoritative information for the sender.

30. The method of claim 25 wherein authenticating the financial transaction information includes determining whether a trusted communications channel provided the financial transaction information.

31. The method of claim 25 wherein authenticating the financial transaction information includes determining whether one or more similar transactions have previously occurred between the sender and the recipient.

32. The method of claim 25 wherein authenticating the financial transaction information includes determining whether a transaction type in the financial transaction information is found in a maintained list of acceptable transaction types.

33. The method of claim 32 wherein determining whether the transaction type is found in the maintained list of acceptable transaction types includes determining whether a scope of the transaction is within the threshold limits established with respect to the maintained list of acceptable transaction types.

34. The method of claim 33 wherein determining whether the transaction type is found in the maintained list of acceptable transaction types includes determining whether an amount of the transaction is within the threshold limits established with respect to the maintained list of acceptable transaction types.

35. The method of claim 33 wherein determining whether the transaction type is found in the maintained list of acceptable transaction types includes determining whether a type of goods or services in the financial transaction information is within the threshold limits established with respect to the maintained list of acceptable transaction types.

36. The method of claim 33 wherein determining whether the transaction type is found in the maintained list of acceptable transaction types includes determining whether a vendor of goods or services in the financial transaction information is within the threshold limits established with respect to the maintained list of acceptable transaction types.

37. The method of claim 25 wherein packaging the financial transaction information as the transaction includes:
retrieving user financial information associated with a user enrolled in a bill payment service,
associating the user financial information with the financial transaction information; and
storing a pending transaction so that the recipient may interact with the trusted transaction message to execute the pending transaction.

38. A computer program product that when executed generates a graphical user interface enabling a user to execute a transaction, the graphical user interface comprising:
an inbox region illustrating a trusted transaction message alongside other messages that are not trusted transaction messages; and
a trusted mail message code segment indicating that the trusted transaction mail message has been authenticated and enabling a recipient to execute a transaction by interacting with the transaction in the trusted transaction mail message.

39. The computer program product of claim 38 further comprising a reminder icon enabling a user to be reminded of the transaction appearing in the trusted transaction message.

40. The computer program product of claim 38 further comprising a calendar icon enabling a user to enter an event for the transaction in a calendaring system.

41. The computer program product of claim 38 further comprising a help icon enabling a user to report fraud.

42. The computer program product of claim 38 further comprising a help icon that to establish a Voice Over Internet Protocol session with a call center.

43. The computer program product of claim 38 further comprising a help icon to request a call back to a telephone from a customer service representative.

44. The computer program product of claim 41 wherein the help icon is configured to generate a help message requesting customer service.

45. The computer program product of claim 41 wherein the help icon is configured to provide customer and transaction information in the help message.

46. The computer program product of claim 41 wherein the help icon is configured to provide the help message to the customer call center.
